(19) United States
(12) Patent Application Publication
(10) Pub. No.: US 2015/0223246 A1
(43) Pub. Date: Aug. 6, 2015

(54) SYSTEMS AND METHODS FOR IMPROVED COMMUNICATION EFFICIENCY IN HIGH EFFICIENCY WIRELESS NETWORKS

(71) Applicant: QUALCOMM Incorporated, San Diego, CA (US)

(72) Inventors: Lin Yang, San Diego, CA (US); Bin Tian, San Diego, CA (US); Sameer Vermani, San Diego, CA (US)

(21) Appl. No.: 14/612,891

(22) Filed: Feb. 3, 2015

Related U.S. Application Data
(60) Provisional application No. 61/936,286, filed on Feb. 5, 2014.

(51) Int. Cl. H04W 72/04; H04W 4/12

(52) U.S. Cl. CPC H04W 72/0453; H04W 4/12; H04W 88/06

(57) ABSTRACT

Methods and apparatus methods and apparatus for providing wireless messages according to various tone plans. One aspect of the disclosure provides an apparatus including a processing system. The processing system is configured to select from one of a 256-, 512-, 1024-, and 2048-tone plan for wireless communication of a message. The processing system is further configured to, upon selecting the 256-tone plan, provide the message for transmission over a 20 MHz bandwidth. The processing system is further configured to, upon selecting the 512-tone plan, provide the message for transmission over a 40 MHz bandwidth. The processing system is further configured to, upon selecting the 1024-tone plan, provide the message for transmission over a 80 MHz bandwidth. The processing system is further configured to, upon selecting the 2048-tone plan, provide the message for transmission over a 160 MHz bandwidth.

### CROSS-REFERENCE TO RELATED APPLICATIONS

The present application claims priority to U.S. Provisional Application No. 61/936,286, filed Feb. 5, 2014, which is hereby incorporated by reference herein.

### FIELD

Certain aspects of the present disclosure generally relate to wireless communications, and more particularly, to methods and apparatus for providing messages according to various tone plans.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network can transmit/receive information between each other. Device transmissions can interfere with each other, and certain transmissions can selectively block other transmissions. Where many devices share a communication network, congestion and inefficient link usage can result. As such, systems, methods, and non-transitory computer-readable media are needed for improving communication efficiency in high efficiency wireless networks.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an apparatus including a processing system. The processing system is configured to select from one of a 256-, 512-, 1024-, and 2048-tone plan for wireless communication of a message. The processing system is further configured to, upon selecting the 256-tone plan, provide the message for transmission over a 20 MHz bandwidth. The processing system is further configured to, upon selecting the 512-tone plan, provide the message for transmission over a 40 MHz bandwidth. The processing system is further configured to, upon selecting the 1024-tone plan, provide the message for transmission over a 80 MHz bandwidth. The processing system is further configured to, upon selecting the 2048-tone plan, provide the message for transmission over a 160 MHz bandwidth.

In various aspects, selecting the tone plan can include multiplying a 4 μs tone plan size by four. In various aspects, the message can include a symbol duration of 16 μs.

In various aspects, providing the message for transmission can include encoding the message according to the selected tone plan. Providing the message for transmission can further include providing the encoded message for transmission.

In various aspects, the 512-, 1024-, and 2048-tone plans can each include the 256-tone plan repeated 2, 4, and 8 times, respectively, in the frequency domain. In various aspects, the 1024-tone plan can include 936 data tones, and the 2048-tone plan can include 1872 data tones.

In various aspects, the 1024-, and 2048-tone plans can each include the 256-tone plan repeated 4, and 8 times, respectively, in the frequency domain. One or more mid-tones and direct current (DC) tones of the 256-tone plan can be replaced with at least one of data or pilot tones. In various aspects, the 512-tone plan can include the 256-tone plan repeated 2 times in the frequency domain. In various aspects, mid-tones or direct current (DC) tones of the 256-tone plan are not replaced with at least one of data or pilot tones. In various aspects, the 1024-tone plan can include 976 data tones, and the 2048-tone plan can include 1968 data tones.

In various aspects, the 256-tone plane can include a 64-tone plan repeated in the frequency domain, the 512-tone plane can include a 128-tone plan repeated in the frequency domain, the 1024-tone plane can include a second 256-tone plan repeated in the frequency domain, the 2048-tone plane can include a second 512-tone plan repeated in the frequency domain. In various aspects, the 256-tone plan can be different from the second 256-tone plan, the 512-tone plan can be different from the second 512-tone plan. In various aspects, the 256-tone plan can include the second 256-tone plan, and the 512-tone plan can include the second 512-tone plan.

In various aspects, a symbol duration of the 256-, 512-, 1024-, and 2048-tone plan can be 4 times a symbol duration of the 64-tone plan, the 128-tone plan, the second 256-tone plan, and the second 512-tone plan, respectively

Another aspect provides a method of wireless communication. The method includes selecting from one of a 256-, 512-, 1024-, and 2048-tone plan for communication of a message. The method further includes, upon selecting the 256-tone plan, providing the message for transmission over a 20 MHz bandwidth. The method further includes, upon selecting the 512-tone plan, providing the message for transmission over a 40 MHz bandwidth. The method further includes, upon selecting the 1024-tone plan, providing the message for transmission over a 80 MHz bandwidth. The method further includes, upon selecting the 2048-tone plan, providing the message for transmission over a 160 MHz bandwidth.

In various aspects, selecting the tone plan can include multiplying a 4 μs tone plan size by four. In various aspects, the message can include a symbol duration of 16 μs.

In various aspects, providing the message for transmission can include encoding the message according to the selected tone plan. Providing the message for transmission can further include providing the encoded message for transmission.

In various aspects, the 512-, 1024-, and 2048-tone plans can each include the 256-tone plan repeated 2, 4, and 8 times, respectively, in the frequency domain. In various aspects, the 1024-tone plan can include 936 data tones, and the 2048-tone plan can include 1872 data tones.

In various aspects, the 1024-, and 2048-tone plans can each include the 256-tone plan repeated 4, and 8 times, respectively, in the frequency domain. One or more mid-tones and direct current (DC) tones of the 256-tone plan can be replaced with at least one of data or pilot tones. In various aspects, the 512-tone plan can include the 256-tone plan repeated 2 times in the frequency domain. In various aspects, mid-tones or direct current (DC) tones of the 256-tone plan are not replaced with at least one of data or pilot tones. In various aspects, the 1024-tone plan can include 976 data tones, and the 2048-tone plan can include 1968 data tones.

In various aspects, the 256-tone plane can include a 64-tone plan repeated in the frequency domain, the 512-tone plane can include a 128-tone plan repeated in the frequency domain, the 1024-tone plane can include a second 256-tone plan repeated in the frequency domain, the 2048-tone plane can include a second 512-tone plan repeated in the frequency domain. In various aspects, the 256-tone plan can be different from the second 256-tone plan, the 512-tone plan can be different from the second 512-tone plan. In various aspects, the 256-tone plan can include the second 256-tone plan, and the 512-tone plan can include the second 512-tone plan.

In various aspects, a symbol duration of the 256-, 512-, 1024-, and 2048-tone plan can be 4 times a symbol duration of the 64-tone plan, the 128-tone plan, the second 256-tone plan, and the second 512-tone plan, respectively

Another aspect provides an apparatus for wireless communication. The apparatus includes means for selecting from one of a 256-, 512-, 1024-, and 2048-tone plan for communication of a message. The apparatus further includes means for, upon selecting the 256-tone plan, providing the message for transmission over a 20 MHz bandwidth. The apparatus further includes means for, upon selecting the 512-tone plan, providing the message for transmission over a 40 MHz bandwidth. The apparatus further includes means for, upon selecting the 1024-tone plan, providing the message for transmission over a 80 MHz bandwidth. The apparatus further includes means for, upon selecting the 2048-tone plan, providing the message for transmission over a 160 MHz bandwidth.

In various aspects, selecting the tone plan can include multiplying a 4 μs tone plan size by four. In various aspects, the message can include a symbol duration of 16 μs.

In various aspects, providing the message for transmission can include encoding the message according to the selected tone plan. Providing the message for transmission can further include providing the encoded message for transmission.

In various aspects, the 512-, 1024-, and 2048-tone plans can each include the 256-tone plan repeated 2, 4, and 8 times, respectively, in the frequency domain. In various aspects, the 1024-tone plan can include 936 data tones, and the 2048-tone plan can include 1872 data tones.

In various aspects, the 1024-, and 2048-tone plans can each include the 256-tone plan repeated 4, and 8 times, respectively, in the frequency domain. One or more mid-tones and direct current (DC) tones of the 256-tone plan can be replaced with at least one of data or pilot tones. In various aspects, the 512-tone plan can include the 256-tone plan repeated 2 times in the frequency domain. In various aspects, mid-tones or direct current (DC) tones of the 256-tone plan are not replaced with at least one of data or pilot tones. In various aspects, the 1024-tone plan can include 976 data tones, and the 2048-tone plan can include 1968 data tones.

In various aspects, the 256-tone plane can include a 64-tone plan repeated in the frequency domain, the 512-tone plane can include a 128-tone plan repeated in the frequency domain, the 1024-tone plane can include a second 256-tone plan repeated in the frequency domain, the 2048-tone plane can include a second 512-tone plan repeated in the frequency domain. In various aspects, the 256-tone plan can be different from the second 256-tone plan, the 512-tone plan can be different from the second 512-tone plan. In various aspects, the 256-tone plan can include the second 256-tone plan, and the 512-tone plan can include the second 512-tone plan.

In various aspects, a symbol duration of the 256-, 512-, 1024-, and 2048-tone plan can be 4 times a symbol duration of the 64-tone plan, the 128-tone plan, the second 256-tone plan, and the second 512-tone plan, respectively

Another aspect provides a non-transitory computer-readable medium. The medium includes code that, when executed, causes an apparatus to select from one of a 256-, 512-, 1024-, and 2048-tone plan for wireless communication of a message. The medium further includes code that, when executed, causes the apparatus to, upon selecting the 256-tone plan, provide the message for transmission over a 20 MHz bandwidth. The medium further includes code that, when executed, causes the apparatus to, upon selecting the 512-tone plan, provide the message for transmission over a 40 MHz bandwidth. The medium further includes code that, when executed, causes the apparatus to upon selecting the 1024-tone plan, provide the message for transmission over a 80 MHz bandwidth. The medium further includes code that, when executed, causes the apparatus to upon selecting the 2048-tone plan, provide the message for transmission over a 160 MHz bandwidth.

In various aspects, selecting the tone plan can include multiplying a 4 μs tone plan size by four. In various aspects, the message can include a symbol duration of 16 μs.

In various aspects, providing the message for transmission can include encoding the message according to the selected tone plan. Providing the message for transmission can further include providing the encoded message for transmission.

In various aspects, the 512-, 1024-, and 2048-tone plans can each include the 256-tone plan repeated 2, 4, and 8 times, respectively, in the frequency domain. In various aspects, the 1024-tone plan can include 936 data tones, and the 2048-tone plan can include 1872 data tones.

In various aspects, the 1024-, and 2048-tone plans can each include the 256-tone plan repeated 4, and 8 times, respectively, in the frequency domain. One or more mid-tones and direct current (DC) tones of the 256-tone plan can be replaced with at least one of data or pilot tones. In various aspects, the 512-tone plan can include the 256-tone plan repeated 2 times in the frequency domain. In various aspects, mid-tones or direct current (DC) tones of the 256-tone plan are not replaced with at least one of data or pilot tones. In various aspects, the 1024-tone plan can include 976 data tones, and the 2048-tone plan can include 1968 data tones.

In various aspects, the 256-tone plane can include a 64-tone plan repeated in the frequency domain, the 512-tone plane can include a 128-tone plan repeated in the frequency domain, the 1024-tone plane can include a second 256-tone plan repeated in the frequency domain, the 2048-tone plane can include a second 512-tone plan repeated in the frequency domain. In various aspects, the 256-tone plan can be different from the second 256-tone plan, the 512-tone plan can be different from the second 512-tone plan. In various aspects, the 256-tone plan can include the second 256-tone plan, and the 512-tone plan can include the second 512-tone plan.

In various aspects, a symbol duration of the 256-, 512-, 1024-, and 2048-tone plan can be 4 times a symbol duration of the 64-tone plan, the 128-tone plan, the second 256-tone plan, and the second 512-tone plan, respectively

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 shows an exemplary 2N-tone plan, according to one aspect.

FIG. 4A shows an exemplary 256-tone plan, according to one aspect.

FIG. 4B shows an exemplary 512-tone plan, according to one aspect.

FIG. 4C shows an exemplary 1024-tone plan, according to one aspect.

FIG. 4D shows an exemplary 2048-tone plan, according to one aspect.

FIG. 5A shows another exemplary 1024-tone plan, according to one aspect.

FIG. 5B shows another exemplary 2048-tone plan, according to one aspect.

FIG. 6A shows another exemplary 256-tone plan, according to one aspect.

FIG. 6B shows another exemplary 512-tone plan, according to one aspect.

FIG. 6C shows another exemplary 1024-tone plan, according to one aspect.

FIG. 6D shows another exemplary 2048-tone plan, according to one aspect.

FIG. 7 shows a flowchart for an exemplary method of wireless communication that can be employed within the wireless communication system of FIG. 1.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol can be used for Internet access, sensors, metering, smart grid networks, or other wireless applications. Advantageously, aspects of certain devices implementing this particular wireless protocol can consume less power than devices implementing other wireless protocols, can be used to transmit wireless signals across short distances, and/or can be able to transmit signals less likely to be blocked by objects, such as humans.

In some implementations, a WLAN includes various devices which are the components that access the wireless network. For example, there can be two types of devices: access points (“APs”) and clients (also referred to as stations, or “STAs”). In general, an AP serves as a hub or base station for the WLAN and an STA serves as a user of the WLAN. For example, a STA can be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA can also be used as an AP.

The techniques described herein can be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system can utilize sufficiently different directions to concurrently transmit data belonging to multiple user terminals. A TDMA system can allow multiple user terminals to share the same frequency channel by dividing the transmission signal into different time slots, each time slot being assigned to different user terminal. A TDMA system can implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers can also be called tones, bins, etc. With OFDM, each sub-carrier can be independently modulated with data. An OFDM system can implement IEEE 802.11 or some other standards known in the art. An SC-FDMA system can utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system can implement 3GPP-LTE (3rd Generation Partnership Project Long Term Evolution) or other standards.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein can implement the 802.11ah standard, for example. Such devices, whether used as an STA or AP or other device, can be used for smart metering or in a smart grid network. Such devices can provide sensor applications or be used in home automation. The devices can instead or in addition be used in a healthcare context, for example for personal healthcare. They can also be used for surveillance, to enable extended-range Internet connectivity (e.g., for use with hotspots), or to implement machine-to-machine communications.

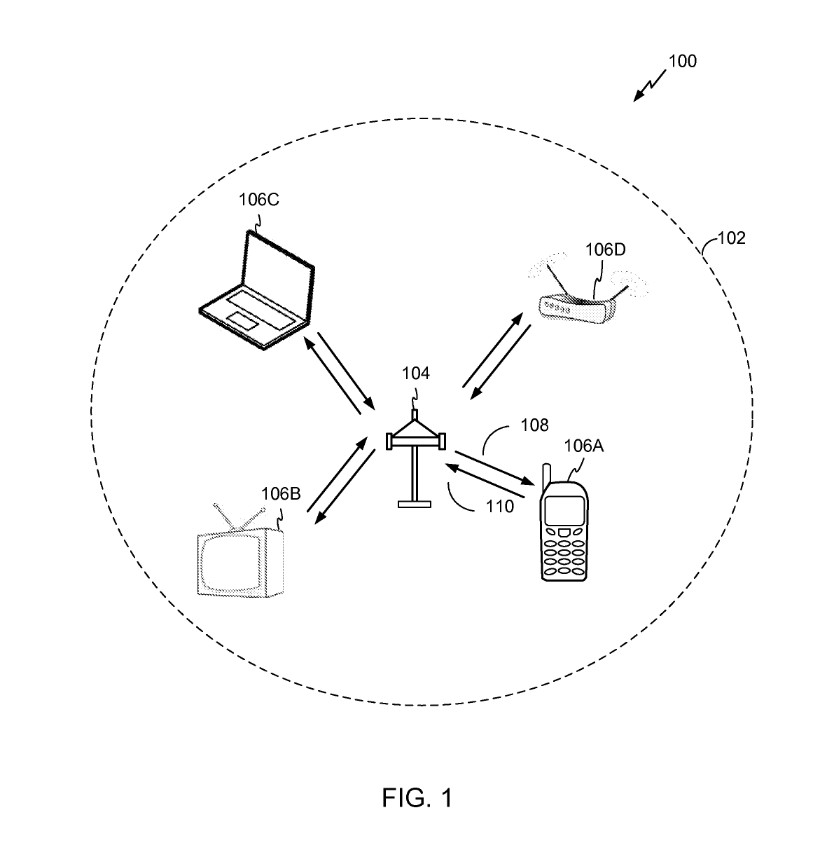

FIG. 1 illustrates an example of a wireless communication system 100 in which aspects of the present disclosure can be employed. The wireless communication system 100 can operate pursuant to a wireless standard, for example at least one of the 802.11ah, 802.11ac, 802.11n, 802.11g and 802.11b standards. The wireless communication system 100 can include an AP 104, which communicates with STAs 106.

A variety of processes and methods can be used for transmissions in the wireless communication system 100 between the AP 104 and the STAs 106. For example, signals can be transmitted and received between the AP 104 and the STAs 106 in accordance with OFDM/OFDMA techniques. If this is the case, the wireless communication system 100 can be referred to as an OFDM/OFDMA system. Alternatively, signals can be transmitted and received between the AP 104 and the STAs 106 in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

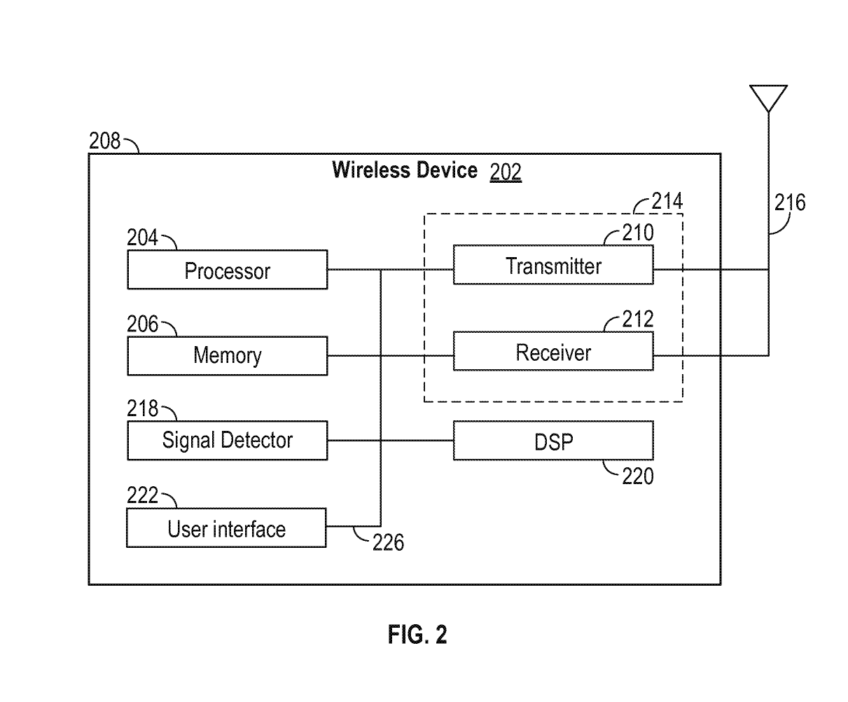

FIG. 2 illustrates various components that can be utilized in a wireless device 202 that can be employed within the wireless communication system 100. The wireless device 202 is an example of a device that can be configured to implement the various methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can comprise a physical layer data unit (PPDU). In some aspects, the PPDU is referred to as a packet.

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. Those of skill in the art will appreciate the components of the wireless device 202 can be coupled together or accept or provide inputs to each other using some other mechanism.

Although a number of separate components are illustrated in FIG. 2, those of skill in the art will recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

As discussed above, the wireless device 202 can comprise an AP 104 or an STA 106, and can be used to transmit and/or receive communications. The communications exchanged between devices in a wireless network can include data units which can comprise packets or frames. In some aspects, the data units can include data frames, control frames, and/or management frames. Data frames can be used for transmitting data from an AP and/or a STA to other APs and/or STAs. Control frames can be used together with data frames for performing various operations and for reliably delivering data (e.g., acknowledging receipt of data, polling of APs, area-clearing operations, channel acquisition, carrier-sensing maintenance functions, etc.). Management frames can be used for various supervisory functions (e.g., for joining and departing from wireless networks, etc.).

Certain aspects of the present disclosure support allowing APs 104 to allocate STAs 106 transmissions in optimized ways to improve efficiency. Both high efficiency wireless (HEW) stations, stations utilizing an 802.11 high efficiency protocol (such as 802.11ax), and stations using older or legacy 802.11 protocols (such as 802.11b), can compete or coordinate for access to a wireless medium. In some aspects, the high-efficiency 802.11 protocol described herein can allow for HEW and legacy stations to interoperate according to various OFDM tone plans (which can also be referred to as tone maps). In some aspects, HEW stations can access the wireless medium in a more efficient manner. Accordingly, in the case of apartment buildings or densely-populated public spaces, APs and/or STAs that use the high-efficiency 802.11 protocol can experience reduced latency and increased network throughput even as the number of active wireless devices increases, thereby improving user experience.

In some aspects, APs 104 can transmit on a wireless medium according to various DL tone plans for HEW STAs. For example, with respect to FIG. 1, the STAs 106A-106D can be HEW STAs. In some aspects, the HEW STAs can communicate using a symbol duration four times that of a legacy STA. For example, in various aspects, a 1× symbol duration can be 4 ms and a 4× symbol duration can be 16 ms. The AP 104 can transmit messages to the HEW STAs 106A-106D according to one or more tone plans, based on a communication bandwidth.

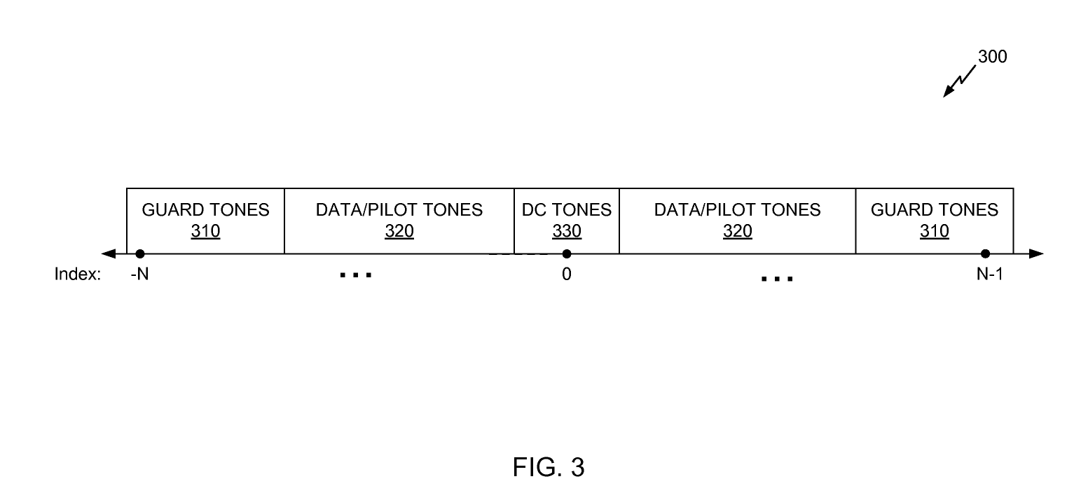

FIG. 3 shows an exemplary 2N-tone plan 300, according to one aspect. In an aspect, the tone plan 300 corresponds to OFDM tones, in the frequency domain, generated using a 2N-point FFT. The tone plan 300 includes 2N OFDM tones indexed −N to N-1. The tone plan 300 includes two sets of guard tones 310, two sets of data/pilot tones 320, and a set of direct current (DC) tones 330. In various aspects, the guard tones 310 and DC tones 330 can be null. In various aspects, the tone plan 300 includes another suitable number of pilot tones and/or includes pilot tones at other suitable tone locations.

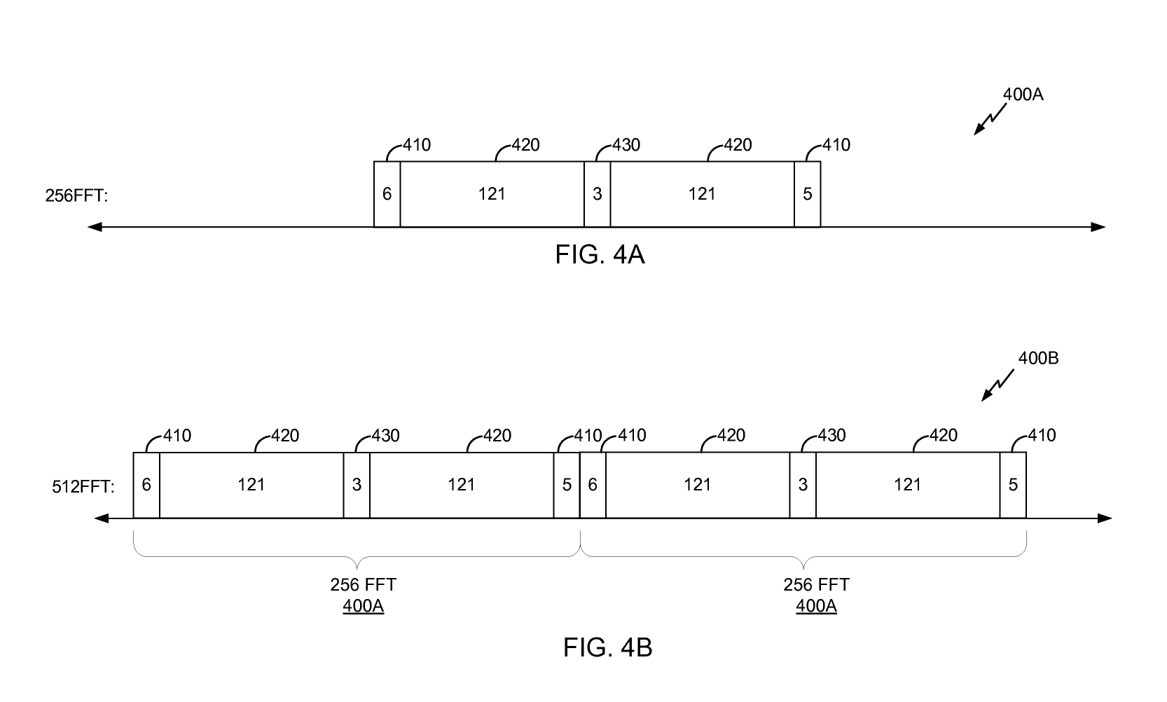

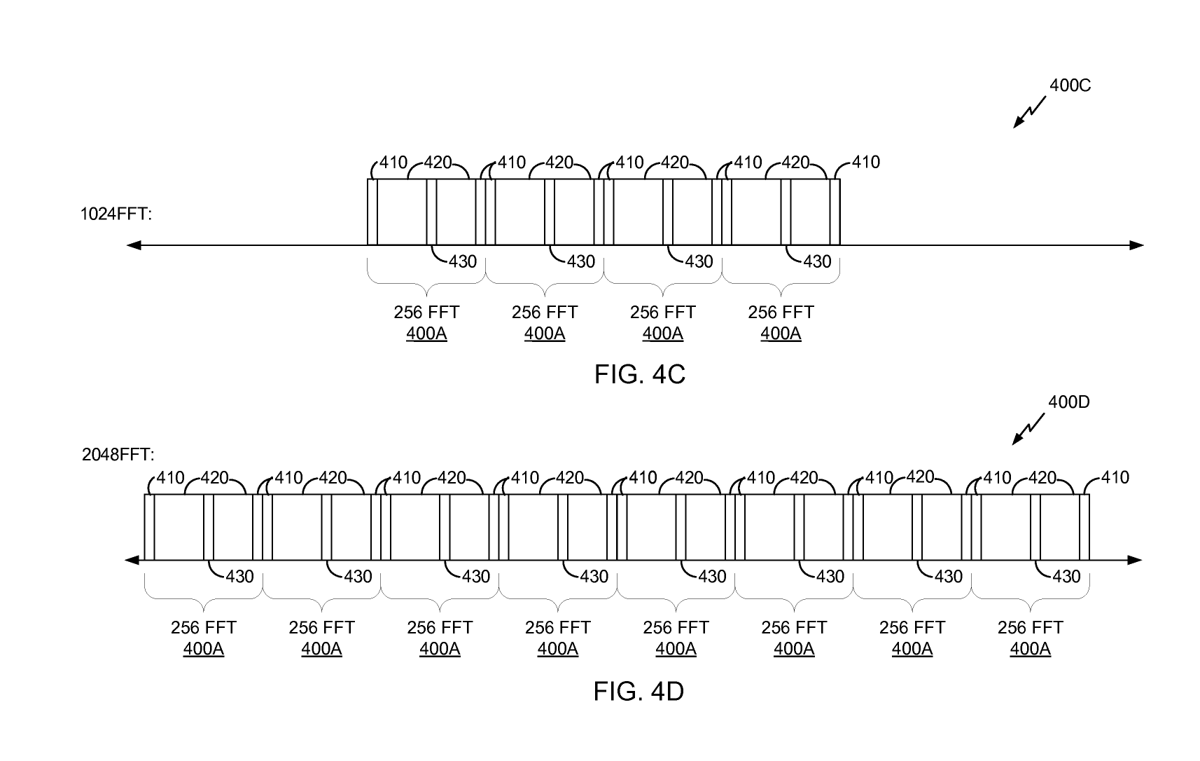

Although a 2N-tone plan 300 is shown in FIG. 3, similar tone plans can be used (such as 32-, 48-, 64-, 96-, 128-, 192-, 256-, 320-, 384-, 448-, 512-, 768-, 1024, 1280-, 1536-, 1792-, and 2048-tone plans). In various aspects, each tone plan can correspond to a communication bandwidth such as, for example, 20 MHz, 40 MHz, 80 MHz, and 160 MHz. As discussed below with respect to FIGS. 4A-4D, in various aspects, 512-, 1024, and 2048-tone plans can include a 256-tone plan, repeated 2, 4, and 8 times, respectively, in the frequency domain. In one aspect, the 256-tone plan can include the very high throughput (VHT) 80 MHz tone plan defined in an IEEE 802.11 standard.

FIG. 4A shows an exemplary 256-tone plan 400A, according to one aspect. In an aspect, the tone plan 400A corresponds to OFDM tones, in the frequency domain, generated using a 256-point FFT. The tone plan 400A includes 256 OFDM tones indexed −128 to 127. The tone plan 400A includes two sets of guard tones 410, two sets of data/pilot tones 420, and a set of direct current (DC) tones 430. In the illustrated aspect, there are 6+5 guard tones 410, which can be null. In the illustrated aspect, there are 3 DC tones 430, which can be null. In the illustrated aspect, there are 121+121 data/pilot tones 420, which can include 234 data tones and 8 pilot tones. In various aspects, the tone plan 400A can include another suitable number of pilot tones and/or includes pilot tones at other suitable tone locations. In various aspects, the 256-tone plan 400A can be used for communications in a 20 MHz band, with a 4× symbol duration.

FIG. 4B shows an exemplary 512-tone plan 400B, according to one aspect. In an aspect, the tone plan 400B corresponds to OFDM tones, in the frequency domain, generated using a 512-point FFT. The tone plan 400B includes 512 OFDM tones indexed −256 to 255. The tone plan 400B includes the 256-tone plan 400A (discussed above with respect to FIG. 4A) repeated twice in the frequency domain. In the illustrated aspect, the center guard tones 410 can act as DC tones. In the illustrated aspect, the DC tones 430 can be referred to as mid-tones. In the illustrated aspect, there are 121+121+121+121 data/pilot tones 420, which can include 468 data tones and 16 pilot tones. In various aspects, the tone plan 400B can include another suitable number of pilot tones and/or includes pilot tones at other suitable tone locations. In various aspects, the 512-tone plan 400B can be used for communications in a 40 MHz band, with a 4× symbol duration.

FIG. 4C shows an exemplary 1024-tone plan 400C, according to one aspect. In an aspect, the tone plan 400C corresponds to OFDM tones, in the frequency domain, generated using a 1024-point FFT. The tone plan 400C includes 1024 OFDM tones indexed −512 to 511. The tone plan 400C includes the 256-tone plan 400A (discussed above with respect to FIG. 4A) repeated four times in the frequency domain. In the illustrated aspect, the center guard tones 410 can act as DC tones. In the illustrated aspect, the guard tones 410 and DC tones 430 that are between the edges can be referred to as mid-tones. In the illustrated aspect, there are 968 data/pilot tones 420, which can include 936 data tones and 32 pilot tones. In various aspects, the tone plan 400C can include another suitable number of pilot tones and/or includes pilot tones at other suitable tone locations. In various aspects, the 1024-tone plan 400C can be used for communications in a 80 MHz band, with a 4× symbol duration.

FIG. 4D shows an exemplary 2048-tone plan 400D, according to one aspect. In an aspect, the tone plan 400D corresponds to OFDM tones, in the frequency domain, generated using a 2048-point FFT. The tone plan 400D includes 2048 OFDM tones indexed −1024 to 1023. The tone plan 400D includes the 256-tone plan 400A (discussed above with respect to FIG. 4A) repeated eight times in the frequency domain. In the illustrated aspect, the center guard tones 410 can act as DC tones. In the illustrated aspect, the guard tones 410 and DC tones 430 that are between the edges can be referred to as mid-tones. In the illustrated aspect, there are 1936 data/pilot tones 420, which can include 1872 data tones and 64 pilot tones. In various aspects, the tone plan 400D can include another suitable number of pilot tones and/or includes pilot tones at other suitable tone locations. In various aspects, the 2048-tone plan 400D can be used for communications in a 160 MHz band, with a 4× symbol duration.

Table 1, below, shows exemplary tone plans for various bandwidths and corresponding FFT sizes at a 4× symbol duration, according to various aspects. A person having ordinary skill in the art will appreciate that other combinations of data, pilot, DC, and guard tones can be used.

TABLE 1

| Bandwidth | FFT | Data | Pilot | Guard | Mid- | DC |
|---|---|---|---|---|---|---|
| (MHz) | Size | Tones | Tones | Tones | Tones | Tones |
| 20 | 256 | 234 | 8 | 11 | 0 | 3 |
| 40 | 512 | 468 | 16 | 11 | 6 | 11 |
| 80 | 1024 | 936 | 32 | 11 | 34 | 11 |
| 160 | 2048 | 1872 | 64 | 11 | 90 | 11 |

As discussed above with respect to FIGS. 4A-4D, in various aspects one or more of the 512-, 1024-, and 2048-tone plans can include a 256-tone plan repeated. In the aspects discussed above with respect to FIGS. 4A-4D, the mid-tones are not used for data or pilot tones. In various aspects, one or more wireless devices implementing the tone plans of FIGS. 4A-4D can include a frequency segment parser configured to separate messages into 256-tone plan segments. Advantageously, receivers can perform separate phase tracking, smoothing, and de-interleaving on each 256-tone plan segment. In various aspects, per-sub-band tracking can mitigate inter-carrier interference (ICI), for example introduced by sampling clock offset.

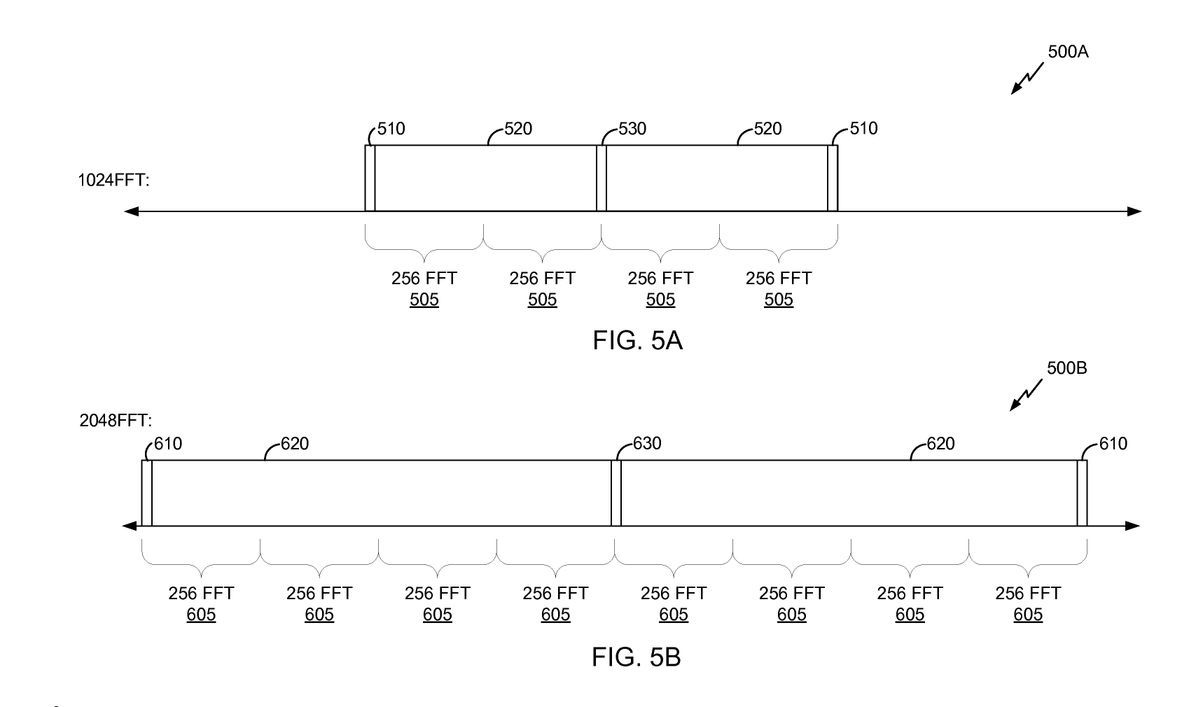

As discussed below with respect to FIGS. 5A-5B, in other aspects, one or more of the 1024- and 2048-tone plans can include as 256-tone plan repeated, but with one or more mid-tones replaced with at least one of data or pilot tones. Thus, in some aspects, throughput can be increased. Such implementations can include an interleaver configured to decode the 1024- and/or 2048-tone plans.

FIG. 5A shows another exemplary 1024-tone plan 500A, according to one aspect. In an aspect, the tone plan 500A corresponds to OFDM tones, in the frequency domain, generated using a 1024-point FFT. The tone plan 500A includes 1024 OFDM tones indexed −512 to 511. The tone plan 500A includes a 256-tone plan 505 repeated four times in the frequency domain. In an aspect, the 256-tone plan 505 can include the 256-tone plan 400A (discussed above with respect to FIG. 4A) repeated with the mid-tones being replaced with at least one of data or pilot tones 520. In the illustrated aspect, the tone plan 500A includes two sets of guard tones 510, two sets of data/pilot tones 520, and a set of DC tones 530. In the illustrated aspect, there are 1008 data/pilot tones 520, which can include 976 data tones and 32 pilot tones. In various aspects, the tone plan 500A can include another suitable number of pilot tones and/or includes pilot tones at other suitable tone locations. In various aspects, the 1024-tone plan 500A can be used for communications in a 80 MHz band, with a 4× symbol duration.

FIG. 5B shows another exemplary 2048-tone plan 500A, according to one aspect. In an aspect, the tone plan 500A corresponds to OFDM tones, in the frequency domain, generated using a 2048-point FFT. The tone plan 500A includes 2048 OFDM tones indexed −1024 to 1023. The tone plan 500B includes a 256-tone plan 605 repeated eight times in the frequency domain. In an aspect, the 256-tone plan 605 can include the 256-tone plan 400A (discussed above with respect to FIG. 4A) repeated with the mid-tones being replaced with at least one of data or pilot tones 520. In the illustrated aspect, the tone plan 500A includes two sets of guard tones 510, two sets of data/pilot tones 520, and a set of DC tones 530. In the illustrated aspect, there are 2032 data/pilot tones 520, which can include 1968 data tones and 64 pilot tones. In various aspects, the tone plan 500A can include another suitable number of pilot tones and/or includes pilot tones at other suitable tone locations. In various aspects, the 2048-tone plan 500A can be used for communications in a 160 MHz band, with a 4× symbol duration.

Table 2, below, shows exemplary tone plans for various bandwidths and corresponding FFT sizes at a 4× symbol duration, according to various aspects. A person having ordinary skill in the art will appreciate that other combinations of data, pilot, DC, and guard tones can be used.

TABLE 2

| Bandwidth | FFT | Data | Pilot | Guard | Mid- | DC |
|---|---|---|---|---|---|---|
| (MHz) | Size | Tones | Tones | Tones | Tones | Tones |
| 20 | 256 | 234 | 8 | 11 | 0 | 3 |
| 40 | 512 | 468 | 16 | 11 | 6 | 11 |
| 80 | 1024 | 976 | 32 | 11 | 0 | 5 |
| 160 | 2048 | 1968 | 64 | 11 | 0 | 5 |

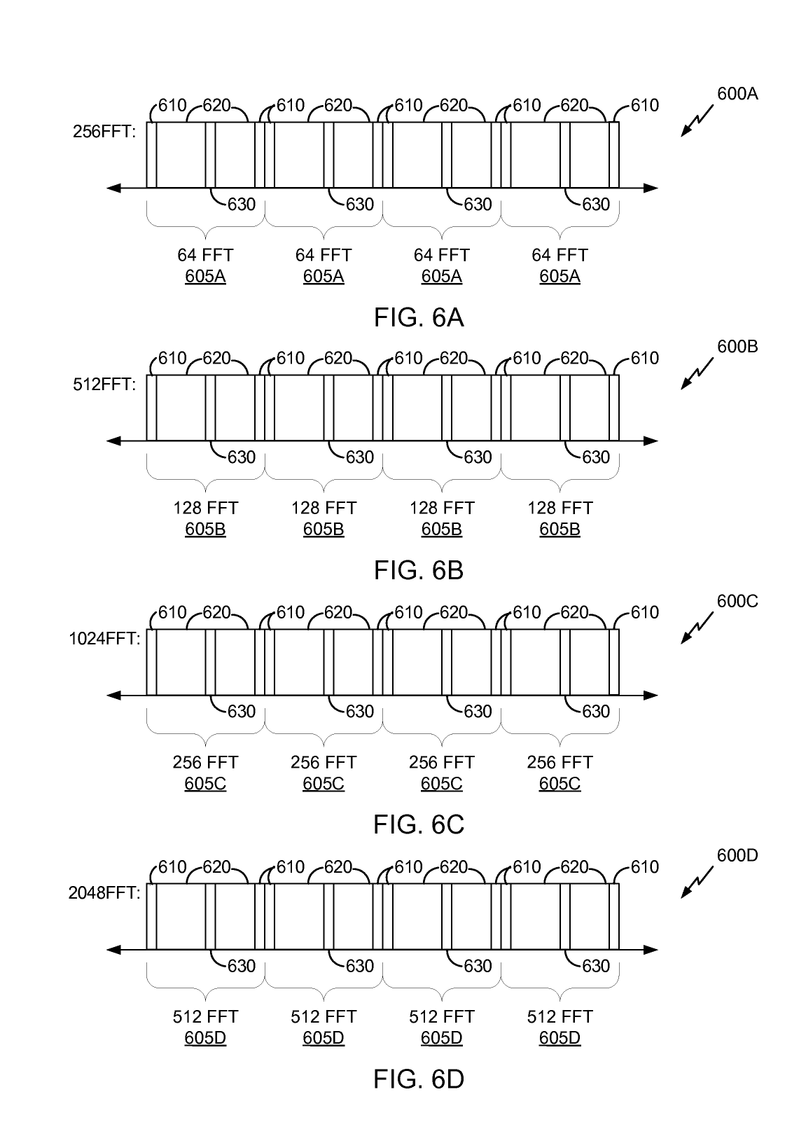

As discussed below with respect to FIGS. 6A-6D, in other aspects, one or more of the 256-, 512-, 1024-, and 2048-tone plans can include another 64-, 128-, 256-, or 512-tone plan, respectively, repeated four times in the frequency domain. Thus, in some aspects, modem reuse can be increased. Such implementations can include one or more frequency segment parsers configured to separate messages into 64-, 128-, 256-, and/or 512-tone plan segments.

FIG. 6A shows another exemplary 256-tone plan 600A, according to one aspect. In an aspect, the tone plan 600A corresponds to OFDM tones, in the frequency domain, generated using a 256-point FFT. The tone plan 600A includes 256 OFDM tones indexed −128 to 127. The tone plan 600A includes a 64-tone plan 605A repeated four times in the frequency domain. In some aspects, the 64-tone plan can include a VHT 20 MHz tone plan defined in an IEEE 802.11 standard.

In the illustrated aspect the mid-tones are not replaced with at least one of data or pilot tones 620. Thus, the tone plan 600A includes guard tones 610 and DC tones 630, which can be null, some of which can be referred to as mid-tones. In other aspects, one or more mid-tones can be replaced with at least one of data or pilot tones 620. In the illustrated aspect, there are 224 data/pilot tones 620, which can include 208 data tones and 16 pilot tones. In various aspects, the tone plan 600A can include another suitable number of pilot tones and/or includes pilot tones at other suitable tone locations. In various aspects, the 256-tone plan 600A can be used for communications in a 20 MHz band, with a 4× symbol duration.

FIG. 6B shows another exemplary 512-tone plan 600B, according to one aspect. In an aspect, the tone plan 600B corresponds to OFDM tones, in the frequency domain, generated using a 512-point FFT. The tone plan 600B includes 512 OFDM tones indexed −256 to 255. The tone plan 600B includes a 128-tone plan 605B repeated four times in the frequency domain. In some aspects, the 128-tone plan can include a VHT 40 MHz tone plan defined in an IEEE 802.11 standard.

In the illustrated aspect the mid-tones are not replaced with at least one of data or pilot tones 620. Thus, the tone plan 600B includes guard tones 610 and DC tones 630, which can be null, some of which can be referred to as mid-tones. In other aspects, one or more mid-tones can be replaced with at least one of data or pilot tones 620. In the illustrated aspect, there are 456 data/pilot tones 620, which can include 432 data tones and 24 pilot tones. In various aspects, the tone plan 600B can include another suitable number of pilot tones and/or includes pilot tones at other suitable tone locations. In various aspects, the 512-tone plan 600B can be used for communications in a 40 MHz band, with a 4× symbol duration.

FIG. 6C shows another exemplary 1024-tone plan 600C, according to one aspect. In an aspect, the tone plan 600C corresponds to OFDM tones, in the frequency domain, generated using a 1024-point FFT. The tone plan 600C includes 1024 OFDM tones indexed −512 to 511. The tone plan 600C includes a 256-tone plan 605C repeated four times in the frequency domain. In some aspects, the 256-tone plan can include a VHT 80 MHz tone plan defined in an IEEE 802.11 standard. In particular, the 256-tone plan 605C can be different from the 256-tone plan 600A, discussed above with respect to FIG. 6A.

In the illustrated aspect the mid-tones are not replaced with at least one of data or pilot tones 620. Thus, the tone plan 600C includes guard tones 610 and DC tones 630, which can be null, some of which can be referred to as mid-tones. In other aspects, one or more mid-tones can be replaced with at least one of data or pilot tones 620. In the illustrated aspect, there are 968 data/pilot tones 620, which can include 936 data tones and 32 pilot tones. In various aspects, the tone plan 600C can include another suitable number of pilot tones and/or includes pilot tones at other suitable tone locations. In various aspects, the 1024-tone plan 600C can be used for communications in an 80 MHz band, with a 4× symbol duration.

FIG. 6D shows another exemplary 2048-tone plan 600D, according to one aspect. In an aspect, the tone plan 600D corresponds to OFDM tones, in the frequency domain, generated using a 2048-point FFT. The tone plan 600D includes 2048 OFDM tones indexed −1024 to 1023. The tone plan 600D includes a 512-tone plan 605D repeated four times in the frequency domain. In some aspects, the 512-tone plan can include a VHT 160 MHz tone plan defined in an IEEE 802.11 standard. In particular, the 512-tone plan 605D can be different from the 512-tone plan 600B, discussed above with respect to FIG. 6B.

In the illustrated aspect the mid-tones are not replaced with at least one of data or pilot tones 620. Thus, the tone plan 600D includes guard tones 610 and DC tones 630, which can be null, some of which can be referred to as mid-tones. In other aspects, one or more mid-tones can be replaced with at least one of data or pilot tones 620. In the illustrated aspect, there are 1936 data/pilot tones 620, which can include 1872 data tones and 64 pilot tones. In various aspects, the tone plan 600D can include another suitable number of pilot tones and/or includes pilot tones at other suitable tone locations. In various aspects, the 2048-tone plan 600D can be used for communications in a 160 MHz band, with a 4× symbol duration.

Table 3, below, shows exemplary tone plans for various bandwidths and corresponding FFT sizes at a 4× symbol duration, according to various aspects. A person having ordinary skill in the art will appreciate that other combinations of data, pilot, DC, and guard tones can be used.

TABLE 3

| Bandwidth | FFT | Data | Pilot | Guard | Mid- | DC |
|---|---|---|---|---|---|---|
| (MHz) | Size | Tones | Tones | Tones | Tones | Tones |
| 20 | 256 | 208 | 16 | 7 | 18 | 7 |
| 40 | 512 | 432 | 24 | 11 | 34 | 11 |
| 80 | 1024 | 936 | 32 | 11 | 34 | 11 |
| 160 | 2048 | 1872 | 64 | 11 | 90 | 11 |

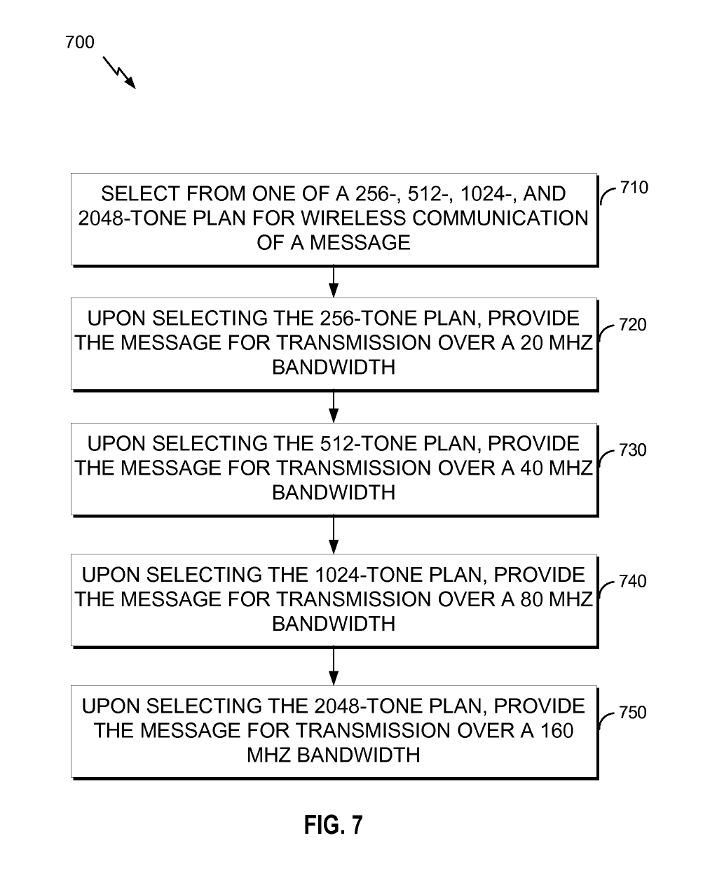

FIG. 7 shows a flowchart 700 for an exemplary method of wireless communication that can be employed within the wireless communication system 100 of FIG. 1. The method can be implemented in whole or in part by the devices described herein, such as the wireless device 202 shown in FIG. 2. Although the illustrated method is described herein with reference to the wireless communication system 100 discussed above with respect to FIG. 1, the wireless device 202 discussed above with respect to FIG. 2, and the tone plans 300A-600D, a person having ordinary skill in the art will appreciate that the illustrated method can be implemented by another device described herein, or any other suitable device. Although the illustrated method is described herein with reference to a particular order, in various aspects, blocks herein can be performed in a different order, or omitted, and additional blocks can be added.

First, at block 710 the device 202 selects from one of a 256-, 512-, 1024-, and 2048-tone plan for wireless communication of a message. For example, the AP 104 can select any of the tone plans 400A-600D according to any of Tables 1-3 above. In various aspects, the AP 104 can select the tone plan by multiplying a 4 μs tone plan size, associated with a 1× symbol duration, by four.

Next, at block 720, the device 202, upon selecting the 256-tone plan, provides the message over a 20 MHz bandwidth. In various aspects, providing the message for transmission can include encoding the message according to the selected tone plan. Providing the message for transmission can further include providing the encoded message for transmission. For example, the AP 104 can encode and/or transmit the message to the STA 106A according to any of the 256-tone plans 400A and 600A, discussed above with respect to FIGS. 4A and 6A. Likewise, the STA 106A can decode and/or receive the message from the AP 104 according to any of the 256-tone plans 400A and 600A, discussed above with respect to FIGS. 4A and 6A.

Then, at block 730, the device 202, upon selecting the 512-tone plan, provides the message over a 40 MHz bandwidth. For example, the AP 104 can encode and/or transmit the message to the STA 106A according to any of the 512-tone plans 400B and 600B, discussed above with respect to FIGS. 4B and 6B. Likewise, the STA 106A can decode and/or receive the message from the AP 104 according to any of the 512-tone plans 400B and 600B, discussed above with respect to FIGS. 4B and 6B.

Thereafter, at block 740, the device 202, upon selecting the 1024-tone plan, provides the message over a 80 MHz bandwidth. For example, the AP 104 can encode and/or transmit the message to the STA 106A according to any of the 1024-tone plans 400C, 500A, and 600C, discussed above with respect to FIGS. 4C, 5A, and 6C. Likewise, the STA 106A can decode and/or receive the message from the AP 104 according to any of the 1024-tone plans 400C, 500A, and 600C, discussed above with respect to FIGS. 4C, 5A, and 6C.

Subsequently, at block 750, the device 202, upon selecting the 2048-tone plan, provides the message over a 160 MHz bandwidth. For example, the AP 104 can encode and/or transmit the message to the STA 106A according to any of the 2048-tone plans 400D, 500B, and 600D, discussed above with respect to FIGS. 4D, 5B, and 6D. Likewise, the STA 106A can decode and/or receive the message from the AP 104 according to any of the 2048-tone plans 400D, 500B, and 600D, discussed above with respect to FIGS. 4D, 5B, and 6D.

In an aspect, the method shown in FIG. 7 can be implemented in a wireless device that can include a selecting circuit, a providing circuit, a processing circuit, an encoding circuit, and/or a providing circuit. Those skilled in the art will appreciate that a wireless device can have more components than the simplified wireless device described herein. The wireless device described herein includes only those components useful for describing some prominent features of implementations within the scope of the claims.

The selecting circuit can be configured to selecting the tone plan for wireless communication of the message. In an aspect, the selecting circuit can be configured to implement block 710 of the flowchart 700 (FIG. 7). The selecting circuit can include one or more of the DSP 220 (FIG. 2), the processor 204 (FIG. 2), and the memory 206 (FIG. 2). In some implementations, means for selecting can include the selecting circuit.

The providing circuit can be configured to provide the message for transmission according to the selected tone plan. In an aspect, the providing circuit can be configured to implement any of blocks 720-750 of the flowchart 700 (FIG. 7). The providing circuit can include one or more of the transmitter 210 (FIG. 2), the transceiver 214 (FIG. 2), the processor 206 (FIG. 2), the DSP 220 (FIG. 2), and the memory 204 (FIG. 2). In some implementations, means for providing can include the providing circuit.

The selecting circuit can be configured to selecting the tone plan for wireless communication of the message. In an aspect, the selecting circuit can be configured to implement block 710 of the flowchart 700 (FIG. 7). The selecting circuit can include one or more of the DSP 220 (FIG. 2), the processor 204 (FIG. 2), and the memory 206 (FIG. 2). In some implementations, means for selecting can include the selecting circuit.

The encoding circuit can be configured to encode the message according to the selected tone plan. The encoding circuit can include one or more of the DSP 220 (FIG. 2), the processor 204 (FIG. 2), and the memory 206 (FIG. 2). In some implementations, means for encoding can include the encoding circuit.

The providing circuit can be configured to provide the encoded message for transmission. The providing circuit can include one or more of the DSP 220 (FIG. 2), the processor 204 (FIG. 2), the memory 206 (FIG. 2), the transmitter 210, the transceiver 214, and the antenna 216. In some implementations, means for providing can include the providing circuit.

The processing circuit can include one or more of the DSP 220 (FIG. 2), the processor 204 (FIG. 2), and the memory 206 (FIG. 2). In some implementations, means for processing can include the processing circuit.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-a, a-b, a-c, b-b, b-c, c-c, and a-b-c.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. An apparatus for wireless communication, comprising:
a processing system configured to:
select from one of a 256-, 512-, 1024-, and 2048-tone plan for wireless communication of a message;
upon selecting the 256-tone plan, provide the message for transmission over a 20 MHz bandwidth;
upon selecting the 512-tone plan, provide the message for transmission over a 40 MHz bandwidth;
upon selecting the 1024-tone plan, provide the message for transmission over a 80 MHz bandwidth; and
upon selecting the 2048-tone plan, provide the message for transmission over a 160 MHz bandwidth.

2. The apparatus of claim 1, wherein the selection is based on a size of the tone plan and a symbol duration of the message.

3. The apparatus of claim 1, wherein the processing system is configured to select the tone plan by multiplying a 4 μs tone plan size by four.

4. The apparatus of claim 1, wherein the processing system is further configured to encode the message according to the selected tone plan.

5. The apparatus of claim 1, wherein the message comprises a symbol duration of 16 μs.

6. The apparatus of claim 1, wherein the 512-, 1024-, and 2048-tone plans comprise the 256-tone plan repeated 2, 4, and 8 times, respectively, in the frequency domain.

7. The apparatus of claim 1, wherein:
the 1024-tone plan comprises 936 data tones; and
the 2048-tone plan comprises 1872 data tones.

8. The apparatus of claim 1, wherein:
the 1024-, and 2048-tone plans comprise the 256-tone plan repeated 4, and 8 times, respectively, in the frequency domain, and
one or more mid-tones and direct current (DC) tones of the 256-tone plan are replaced with at least one of data or pilot tones.

9. The apparatus of claim 1, wherein the 512-tone plan comprises the 256-tone plan repeated 2 times in the frequency domain.

10. The apparatus of claim 8, wherein:
the 1024-tone plan comprises 976 data tones; and
the 2048-tone plan comprises 1968 data tones.

11. The apparatus of claim 1, wherein:
the 256-tone plane comprises a 64-tone plan repeated in the frequency domain;
the 512-tone plane comprises a 128-tone plan repeated in the frequency domain;
the 1024-tone plane comprises a second 256-tone plan repeated in the frequency domain; and
the 2048-tone plane comprises a second 512-tone plan repeated in the frequency domain.

12. The apparatus of claim 11, wherein:
the 256-tone plan is different from the second 256-tone plan; and
the 512-tone plan is different from the second 512-tone plan.

13. The apparatus of claim 11, wherein:
the 256-tone plan comprises the second 256-tone plan; and
the 512-tone plan comprises the second 512-tone plan.

14. The apparatus of claim 11, wherein a symbol duration of the 256-, 512-, 1024-, and 2048-tone plan is 4 times a symbol duration of the 64-tone plan, the 128-tone plan, the second 256-tone plan, and the second 512-tone plan, respectively.

15. A method of wireless communication, comprising:
selecting from one of a 256-, 512-, 1024-, and 2048-tone plan for communication of a message;
upon selecting the 256-tone plan, providing the message for transmission over a 20 MHz bandwidth;
upon selecting the 512-tone plan, providing the message for transmission over a 40 MHz bandwidth;
upon selecting the 1024-tone plan, providing the message for transmission over a 80 MHz bandwidth; and
upon selecting the 2048-tone plan, providing the message for transmission over a 160 MHz bandwidth.

16. The method of claim 15, wherein the selection is based on a size of the tone plan and a symbol duration of the message.

17. The method of claim 15, further comprising selecting the tone plan by multiplying a 4 μs tone plan size by four.

18. The method of claim 15, wherein providing the message for transmission comprises:
encoding the message according to the selected tone plan; and
providing the encoded message for transmission.

19. The method of claim 15, wherein the message comprises a symbol duration of 16 μs.

20. The method of claim 15, wherein the 512-, 1024-, and 2048-tone plans comprise the 256-tone plan repeated 2, 4, and 8 times, respectively, in the frequency domain.

21. The method of claim 15, wherein:
the 1024-tone plan comprises 936 data tones; and
the 2048-tone plan comprises 1872 data tones.

22. The method of claim 15, wherein:
the 1024-, and 2048-tone plans comprise the 256-tone plan repeated 4, and 8 times, respectively, in the frequency domain, and
one or more mid-tones and direct current (DC) tones of the 256-tone plan are replaced with at least one of data or pilot tones.

23. The method of claim 15, wherein the 512-tone plan comprises the 256-tone plan repeated 2 times in the frequency domain.

24. The method of claim 22, wherein:
the 1024-tone plan comprises 976 data tones; and
the 2048-tone plan comprises 1968 data tones.

25. The method of claim 15, wherein:
the 256-tone plane comprises a 64-tone plan repeated in the frequency domain;
the 512-tone plane comprises a 128-tone plan repeated in the frequency domain;
the 1024-tone plane comprises a second 256-tone plan repeated in the frequency domain; and
the 2048-tone plane comprises a second 512-tone plan repeated in the frequency domain.

26. The method of claim 25, wherein:
the 256-tone plan is different from the second 256-tone plan; and
the 512-tone plan is different from the second 512-tone plan.

27. The method of claim 25, wherein:
the 256-tone plan comprises the second 256-tone plan; and
the 512-tone plan comprises the second 512-tone plan.

28. The method of claim 25, wherein a symbol duration of the 256-, 512-, 1024-, and 2048-tone plan is 4 times a symbol duration of the 64-tone plan, the 128-tone plan, the second 256-tone plan, and the second 512-tone plan, respectively

29. An apparatus for wireless communication, comprising:
means for selecting from one of a 256-, 512-, 1024-, and 2048-tone plan for communication of a message;
means for, upon selecting the 256-tone plan, providing the message for transmission over a 20 MHz bandwidth;
means for, upon selecting the 512-tone plan, providing the message for transmission over a 40 MHz bandwidth;
means for, upon selecting the 1024-tone plan, providing the message for transmission over a 80 MHz bandwidth; and
means for, upon selecting the 2048-tone plan, providing the message for transmission over a 160 MHz bandwidth.

30. The apparatus of claim 29, wherein the selection is based on a size of the tone plan and a symbol duration of the message.

31. The method of claim 29, further comprising means for selecting the tone plan by multiplying a 4 μs tone plan size by four.

32. The apparatus of claim 29, wherein means for providing the message for transmission comprises:
means for encoding the message according to the selected tone plan; and
means for providing the encoded message for transmission.

33. The apparatus of claim 29, wherein the message comprises a symbol duration of 16 μs.

34. The apparatus of claim 29, wherein the 512-, 1024-, and 2048-tone plans comprise the 256-tone plan repeated 2, 4, and 8 times, respectively, in the frequency domain.

35. The apparatus of claim 29, wherein:
the 1024-tone plan comprises 936 data tones; and
the 2048-tone plan comprises 1872 data tones.

36. The apparatus of claim 29, wherein:
the 1024-, and 2048-tone plans comprise the 256-tone plan repeated 4, and 8 times, respectively, in the frequency domain, and
one or more mid-tones and direct current (DC) tones of the 256-tone plan are replaced with at least one of data or pilot tones.

37. The apparatus of claim 29, wherein the 512-tone plan comprises the 256-tone plan repeated 2 times in the frequency domain.

38. The apparatus of claim 36, wherein:
the 1024-tone plan comprises 976 data tones; and
the 2048-tone plan comprises 1968 data tones.

39. The apparatus of claim 29, wherein:
the 256-tone plane comprises a 64-tone plan repeated in the frequency domain;
the 512-tone plane comprises a 128-tone plan repeated in the frequency domain;
the 1024-tone plane comprises a second 256-tone plan repeated in the frequency domain; and
the 2048-tone plane comprises a second 512-tone plan repeated in the frequency domain.

40. The apparatus of claim 39, wherein:
the 256-tone plan is different from the second 256-tone plan; and
the 512-tone plan is different from the second 512-tone plan.

41. The apparatus of claim 39, wherein:
the 256-tone plan comprises the second 256-tone plan; and
the 512-tone plan comprises the second 512-tone plan.

42. The apparatus of claim 39, wherein a symbol duration of the 256-, 512-, 1024-, and 2048-tone plan is 4 times a symbol duration of the 64-tone plan, the 128-tone plan, the second 256-tone plan, and the second 512-tone plan, respectively

43. A computer program product comprising a computer readable storage device encoded thereon with instructions that when executed cause an apparatus to:
select from one of a 256-, 512-, 1024-, and 2048-tone plan for wireless communication of a message;
upon selecting the 256-tone plan, provide the message for transmission over a 20 MHz bandwidth;
upon selecting the 512-tone plan, provide the message for transmission over a 40 MHz bandwidth;
upon selecting the 1024-tone plan, provide the message for transmission over a 80 MHz bandwidth; and
upon selecting the 2048-tone plan, provide the message for transmission over a 160 MHz bandwidth.

44. A wireless node, comprising:
an antenna; and
a processing system configured to:
select from one of a 256-, 512-, 1024-, and 2048-tone plan for wireless communication of a message;
upon selecting the 256-tone plan, provide the message for transmission via the antenna over a 20 MHz bandwidth;
upon selecting the 512-tone plan, provide the message for transmission via the antenna over a 40 MHz bandwidth;
upon selecting the 1024-tone plan, provide the message for transmission via the antenna over a 80 MHz bandwidth; and
upon selecting the 2048-tone plan, provide the message for transmission via the antenna over a 160 MHz bandwidth.
